(19) United States
(12) Patent Application Publication
(10) Pub. No.: US 2025/0093894 A1
(43) Pub. Date: Mar. 20, 2025

(54) METHOD AND SYSTEM FOR CONTROLLING TEMPERATURE AND HUMIDITY IN STORAGE DEVICE, AND COMPUTER-READABLE STORAGE MEDIUM

(71) Applicant: GUANGDONG FUXIN TECHNOLOGY CO., LTD, Foshan (CN)

(72) Inventors: Wentian GONG, Foshan (CN); Junling GAO, Foshan (CN); Wenjie LI, Foshan (CN); Guihua WANG, Foshan (CN); Jinshan WANG, Foshan (CN); Baiqin WEN, Foshan (CN)

(21) Appl. No.: 18/964,334

(22) Filed: Nov. 29, 2024

Related U.S. Application Data
(63) Continuation of application No. PCT/CN2024/090172, filed on Apr. 26, 2024.

(30) Foreign Application Priority Data
Jun. 9, 2023 (CN) 202310683439.8

(51) Int. Cl. G05D 27/02; A24F 25/02; F25B 21/04; G05D 22/02; G05D 23/19

(52) U.S. Cl. CPC G05D 27/02; A24F 25/02; G05D 22/02; G05D 23/1917; F25B 21/04; F25B 2321/0212

(57) ABSTRACT

A method for controlling temperature and humidity in a storage device, in which (S1) a set temperature range and a set humidity range of the storage cavity are obtained; (S2) an initial temperature in the storage cavity is obtained, and the temperature in the storage cavity is adjusted by the temperature regulating system to reach the set temperature range; and (S3) an initial humidity in the storage cavity is obtained, and the humidity in the storage cavity is adjusted by the humidifying system and the dehumidifying system to reach the set humidity range. A system for implementing such method includes an acquisition module, a temperature adjustment module and a humidity adjustment module. A computer-readable storage medium stores a computer program, which is configured to be executed by a processor to implement the aforementioned method.

### CROSS-REFERENCE TO RELATED APPLICATIONS

This application is a continuation of International Patent Application No. PCT/CN2024/090172, filed on Apr. 26, 2024, which claims the benefit of priority from Chinese Patent Application No. 202310683439.8, filed on Jun. 9, 2023. The content of the aforementioned application, including any intervening amendments thereto, is incorporated herein by reference in its entirety.

### TECHNICAL FIELD

This application relates to storage equipment, and more specifically to a method and system for controlling temperature and humidity in a storage device, and a computer-readable storage medium.

### BACKGROUND

The consumption of tobacco products has been increasingly growing with the improvement of people's living standards. Tobacco products generally include cigar and cigarette, and the cigar is used as an example herein.

The storage and maintenance of cigars generally requires a specific temperature and humidity, i.e., a temperature of 16-20° C. and a humidity of 60-70%. Currently, the cigars are commonly stored in a wooden cigar box or a wine cabinet. Unfortunately, the existing cigar boxes or wine cabinets cannot satisfactorily and precisely control and regulate the temperature and the humidity therein, thus failing to achieve the long-term storage and maintenance of cigars.

For the long-term preservation of cigars, storage boxes specially designed for the maintenance and storage of cigars have emerged on the market, which generally include a cooling system, a humidifying system and a dehumidifying system. The dehumidifying system in the existing cigar storage boxes generally adopts a physical dehumidification method, i.e., dehumidifying materials such as a desiccant. Nevertheless, the dehumidifying effect of the dehumidifying materials will decline as the time passes, and thus is unstable. Therefore, to ensure a stable dehumidifying effect, it is required to frequently replace the desiccant. In addition, the dehumidifying component using the desiccant has a poorly controllable dehumidifying effect, and cannot be adjusted according to storage requirements, failing to meeting the actual usage requirements.

Although some of the existing cigar storage boxes can be adjusted in terms of the internal temperature and humidity, the influence of the environmental factors on the internal temperature and humidity is not taken into consideration. In particular, when the storage box is exposed to low temperature, high temperature, low humidity and/or high humidity, the temperature and humidity set by the existing methods may deviate from the actual temperature and humidity, resulting in poor preservation effect.

### SUMMARY

The objective of the present disclosure is to provide a method and system for controlling temperature and humidity in a storage device, and a computer-readable storage medium. In this disclosure, the influence of the ambient temperature and humidity on the temperature and humidity in the storage cavity is fully considered, which is conducive to improving the storage and preservation effect of the storage device, so as to overcome the deficiencies in the prior art.

Technical solutions of the present disclosure are described below.

In a first aspect, this application provides a method for controlling temperature and humidity in a storage device, the storage device comprising comprises a storage box, a temperature regulating system, a humidifying system and a dehumidifying system, and the storage box being provided with a storage cavity, and the method comprising:
(S1) obtaining a set temperature range and a set humidity range of the storage cavity;
(S2) obtaining an initial temperature in the storage cavity; and adjusting, by the temperature regulating system, a temperature in the storage cavity to reach the set temperature range according to the initial temperature and the set temperature range; and
(S3) obtaining an initial humidity in the storage cavity; and adjusting, by the humidifying system and the dehumidifying system, a humidity in the storage cavity to reach the set humidity range according to the initial humidity and the set humidity range.

In an embodiment, the temperature regulating system is arranged on the storage box; the temperature regulating system comprises a first conduction assembly, a semiconductor cooling-heating member and a second conduction assembly connected sequentially from inside to outside; the semiconductor cooling-heating member comprises a first working end surface and a second working end surface; the first working end surface is configured to abut the first conduction assembly; the second working end surface is configured to abut the second conduction assembly; the first conduction assembly is configured to face toward the storage cavity; and the second conduction assembly is configured to face toward an outside of the storage box; and
step (S2) comprises:
(S21) obtaining the initial temperature of the storage cavity, and determining whether the initial temperature falls within the set temperature range; if yes, proceeding to step (S23), otherwise, proceeding to step (S22);
(S22) determining whether the temperature regulating system performs a cooling action or a heating action according to the initial temperature of the storage cavity and the set temperature range;
   if the initial temperature of the storage cavity is greater than an upper limit of the set temperature range, performing, by the temperature regulating system, the cooling action until the temperature in the storage cavity falls within the set temperature range, and proceeding to step (S23); and
   if the initial temperature of the storage cavity is less than a lower limit of the set temperature range, performing, by the temperature regulating system, the heating action until the temperature in the storage cavity falls within the set temperature range, and proceeding to step (S23); and
(S23) obtaining a temperature-holding power; adjusting an operating power of the semiconductor cooling-heating member to the temperature-holding power; and dynamically adjusting the first working end surface of the semiconductor cooling-heating member to be a cooling end surface or a heating end surface, so as to keep the temperature in the storage cavity within the set temperature range in real time.

In an embodiment, in step (S23), the step of dynamically adjusting the first working end surface of the semiconductor cooling-heating member to be the cooling end surface or the heating end surface comprises:
obtaining the temperature in the storage cavity in real time;
if the temperature in the storage cavity is greater than or equal to the lower limit of the set temperature range, adjusting the first working end surface of the semiconductor cooling-heating member to be the cooling end surface; and
if the temperature in the storage cavity is less than the lower limit of the set temperature range, adjusting the first working end surface of the semiconductor cooling-heating member to be the heating end surface.

In an embodiment, the temperature-holding power is obtained through steps of:
obtaining a volume of the storage cavity, and obtaining an external ambient temperature and an external ambient humidity of the storage device; and
obtaining the temperature-holding power based on the volume of the storage cavity, the external ambient temperature, the external ambient humidity and the set temperature range.

In an embodiment, the temperature regulating system performs the cooling action through steps of:
obtaining an external ambient temperature of the storage device;
obtaining a cooling power of the semiconductor cooling-heating member based on the initial temperature in the storage cavity, the external ambient temperature, and the set temperature range;
adjusting the first working end surface of the semiconductor cooling-heating member to be the cooling end surface; and
adjusting the operating power of the semiconductor cooling-heating member to be the cooling power to execute the cooling action; and
   the temperature regulating system performs the heating action through steps of:
obtaining the external ambient temperature;

obtaining a heating power of the semiconductor cooling-heating member based on the initial temperature in the storage cavity, the external ambient temperature and the set temperature range;
adjusting the first working end surface of the semiconductor cooling-heating member to be the heating end surface; and
adjusting the operating power of the semiconductor cooling-heating member to be the heating power to execute the heating action.

In an embodiment, the dehumidifying system is arranged on the storage box; the dehumidifying system comprises a semiconductor cooling sheet, a condensation assembly and a heat dissipation assembly connected sequentially from inside to outside; the semiconductor cooling sheet comprises a cooling end surface and a heating end surface; the cooling end surface is configured to abut the condensation assembly, and the heating end surface is configured to abut the heat dissipation assembly; and the condensation assembly is configured to face toward the storage cavity, and the heat dissipation assembly is configured to face toward an outside of the storage box; and
step (S3) comprises:
(S321) turning on the humidifying system, and performing a humidifying action in accordance with preset humidifying parameters, and at the same time, acquiring an initial dehumidifying power; turning on the dehumidifying system; and adjusting an operating power of the semiconductor cooling sheet to the initial dehumidifying power to perform a dehumidifying action;
(S322) obtaining the humidity of the storage cavity, and determining whether the humidity of the storage cavity falls within the set humidity range;
   if the humidity of the storage cavity is not within the set humidity range, proceeding to step (S323); and
   if the humidity of the storage cavity is within the set humidity range, proceeding to step (S324);
(S323) adjusting the operating power of the semiconductor cooling sheet according to the humidity of the storage cavity and the set humidity range;
   if the humidity of the storage cavity is greater than an upper limit of the set humidity range, increasing the operating power of the semiconductor cooling sheet until the humidity of the storage cavity falls within the set humidity range at the same time of acquiring the humidity of the storage cavity in real time, and proceeding to step (S324); and
   if the humidity of the storage cavity is less than a lower limit of the set humidity range, reducing the operating power of the semiconductor cooling sheet until the humidity of the storage cavity falls within the set humidity range at the same time of acquiring the humidity of the storage cavity in real time, and proceeding to step (S324); and
(S324) performing, by the humidifying system, the humidifying action in accordance with the preset humidifying parameters; and performing, by the dehumidifying system, the dehumidifying action in accordance with a current dehumidifying power.

In a second aspect, this application provides a system for controlling temperature and humidity in a storage device, the storage device comprising comprises a storage box, a temperature regulating system, a humidifying system and a dehumidifying system, and the storage box comprising a storage cavity, and the system comprising:
an acquisition module;
a temperature adjustment module; and
a humidity adjustment module;
wherein the acquisition module is configured to obtain a set temperature range and a set humidity range of the storage cavity;
the temperature adjustment module is configured to acquire an initial temperature in the storage cavity, and adjust a temperature in the storage cavity to reach the set temperature range according to the initial temperature and the set temperature range through the temperature regulating system; and
the humidity adjustment module is configured to obtain an initial humidity in the storage cavity, and adjust a humidity in the storage cavity to reach the set humidity range according to the initial humidity and the set humidity range through the humidifying system and the dehumidifying system.

In a third aspect, this application provides a non-transitory computer-readable storage medium, wherein the computer-readable storage medium is configured to store a computer program; and the computer program is configured to be executed by a processor to implement the aforementioned method.

Beneficial effects of the present disclosure are described below.

In the control method and system provided herein, the influence of the external ambient temperature and humidity on the temperature and humidity in the storage cavity is fully considered, which is conducive to improving the storage and preservation effect of the storage device, so as to overcome the deficiencies in the prior art.

### BRIEF DESCRIPTION OF THE DRAWINGS

FIG. 1 is a structural diagram of a storage device involved in a temperature-humidity control method according to an embodiment of the present disclosure;

FIG. 2 is a schematic diagram of a local structure of the storage device according to an embodiment of the present disclosure;

FIG. 3 is a structural diagram of a temperature regulating system of the storage device according to an embodiment of the present disclosure;

FIG. 4 is a structural diagram of a dehumidifying system of the storage device according to an embodiment of the present disclosure;

FIG. 5 is a flow chart of the temperature-humidity control method according to an embodiment of the present disclosure; and

FIG. 6 is a structural block diagram of a temperature-humidity control system according to an embodiment of the present disclosure.

In the drawings: 1—storage box; 101—storage cavity; 2—temperature regulating system; 21—semiconductor cooling-heating member; 22—first conduction assembly; 23—second conduction assembly; 3—humidifying system; 4—dehumidifying system; 41—semiconductor cooling sheet; 42—condensation assembly; and 43—heat dissipation assembly.

### DETAILED DESCRIPTION OF EMBODIMENTS

Embodiments of the present disclosure are described in detail below with reference to the accompanying drawings, where the same or similar labels denote the same or similar elements or elements having the same or similar function throughout the present disclosure. The embodiments described below are exemplary and illustrative, and should not be construed as a limitation of the present disclosure.

In a first aspect, this application provides a method for controlling temperature and humidity in a storage device. The storage device includes a storage box 1, a temperature regulating system 2, a humidifying system 3 and a dehumidifying system 4, and a storage cavity 101 is provided in the storage box 1.

The method includes the following steps.
(S1) A setting temperature range and a set humidity range of the storage cavity 101 are obtained.
(S2) An initial temperature in the storage cavity 101 is acquired, and a temperature in the storage cavity 101 is adjusted by the temperature regulating system 2 to reach the set temperature range according to the initial temperature and the set temperature range.
(S3) An initial humidity in the storage cavity 101 is acquired, and is adjusted by the humidifying system 3 and the dehumidifying system 4 to reach the set humidity range.

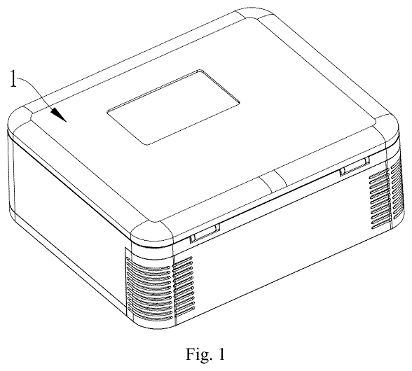

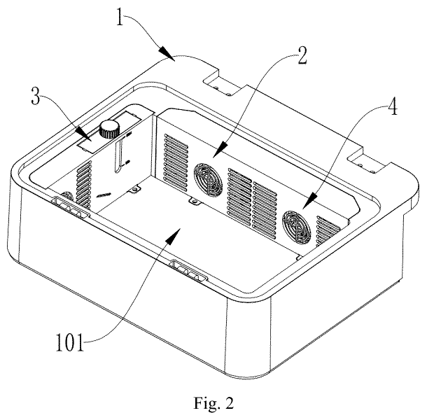

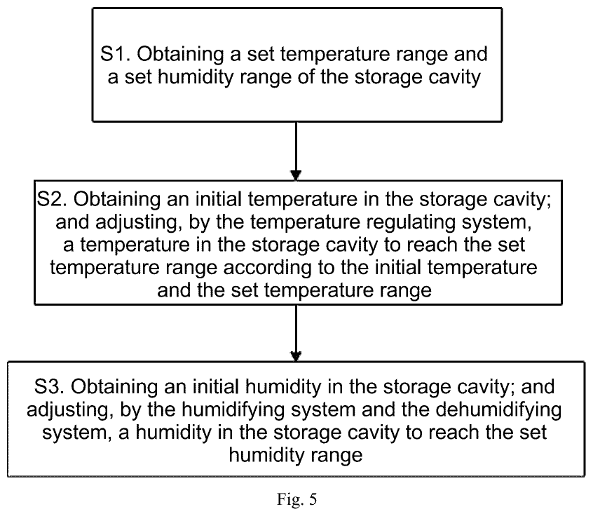

To improve the preservation and maintenance effect of the storage device, the present disclosure provides a method for controlling temperature and humidity in the storage device. The storage device includes a storage box 1, a temperature regulating system 2, a humidifying system 3 and a dehumidifying system 4. As shown in FIGS. 1-5, the temperature regulating system 2 is configured to increase and reduce the temperature in the storage cavity 101, facilitating on-demand adjustment of the intracavity temperature of the storage device. The humidifying system 3 is configured to increase the humidity in the storage cavity 101, and the dehumidifying system 4 is configured to reduce the humidity in the storage cavity 101, facilitating on-demand adjustment of the internal humidity of the storage device.

In general, the two parameters, i.e., the intracavity temperature and the intracavity humidity (i.e., the relative humidity inside the storage cavity 101) of the storage cavity 101 are interrelated, namely, the temperature adjustment affects the humidity change.

As such, the temperature adjustment is prioritized over the humidity control, i.e., the temperature is adjusted firstly to enable the intracavity temperature of the storage cavity 101 to be controlled in the set temperature range; and when the intracavity temperature of the storage cavity 101 has met the requirements, the humidity control is completed, so that the humidity adjustment (humidification/dehumidification) does not have an effect or has a minimal effect on the temperature in the storage cavity 101.

It is to be noted that the step (S1) includes the acquisition of the set temperature range and the set humidity range of the storage cavity 101. In an embodiment, the set temperature range and the set humidity range may be the default range of the temperature and humidity control system of the storage device, which is usually the factory setting of the storage device; or they may be inputted and set by the user through the control panel, the smartphone, and other smart terminals, which are not limited herein.

Further, the temperature regulating system 2 is arranged on the storage box 1. The temperature regulating system includes a first conduction assembly 22, a semiconductor cooling-heating member 21 and a second conduction assembly 23 connected sequentially from inside to outside. The semiconductor cooling-heating member 21 includes a first working end surface and a second working end surface. The first working end surface is configured to abut the first conduction assembly 22, and the second working end surface is configured to abut the second conduction assembly 23. The first conduction assembly 22 is configured to face toward the storage cavity 101, and the second conduction assembly 23 is configured to face toward an outside of the storage box 1.

Step (S2) includes the following steps.

(S21) The initial temperature in the storage cavity 101 is acquired, and whether the initial temperature falls within the set temperature range is determined; if yes, proceeding to step (S23), otherwise, proceeding to step (S22).

(S22) Whether the temperature regulating system performs a cooling action or a heating action is determined according to the initial temperature in the storage cavity 101 and the set temperature range. If the initial temperature in the storage cavity 101 is greater than an upper limit of the set temperature range, the temperature regulating system performs the cooling action until the temperature in the storage cavity 101 falls within the set temperature range, and then step (S23) is performed; and if the initial temperature in the storage cavity 101 is less than a lower limit of the set temperature range, the temperature regulating system performs the heating action until the temperature in the storage cavity 101 falls within the set temperature range, and then step (S23) is performed.

(S23) A temperature-holding power is acquired. An operating power of the semiconductor cooling-heating member 21 is adjusted to the temperature-holding power. The first working end surface of the semiconductor cooling-heating member 21 is dynamically adjusted to be a cooling end surface or a heating end surface, so as to keep the temperature in the storage cavity 101 within the set temperature range in real time.

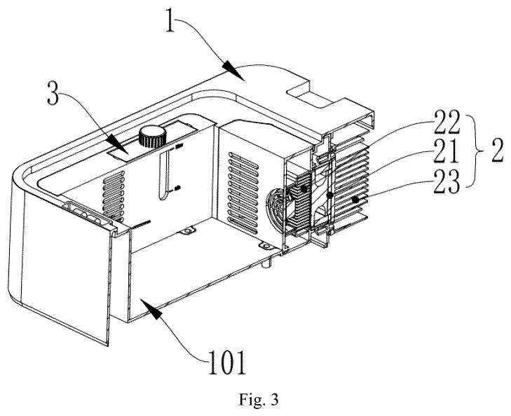

Further, the method provided herein is applied to a temperature regulating system 2 having the semiconductor cooling and heating functions, which includes a first conduction assembly 22, a semiconductor cooling-heating member 21 and a second conduction assembly 23 connected sequentially from inside to outside. The semiconductor cooling-heating member 21 includes a first working end surface and a second working end surface. When the first working end surface is a cooling end surface, the second working end surface is a heating end surface, and the temperature regulating system 2 realizes a cooling function to the storage cavity 101. When the first working end surface is a heating end surface, the second working end surface is a cooling end surface, and the temperature regulating system 2 realizes a heating function to the storage cavity 101, as shown in FIG. 3. The first conduction assembly 22 is configured to transfer the cold or heat generated by the first working end surface of the semiconductor cooling-heating member 21 to the storage cavity 101, and the second conduction assembly 23 is configured to transfer the heat or cold generated by the second working end surface of the semiconductor cooling-heating member 21 to the outside of the storage box 1, so as to enhance the temperature regulation efficiency of the semiconductor cooling-heating member 21.

It should be noted that the semiconductor cooling-heating member 21 used herein is made utilizing the Peltier effect, which refers to the phenomenon that one end of a coupling absorbs heat and the other end excretes heat when a direct current flow passes through an electric coupling composed of two semiconductor materials. As such, by utilizing the Peltier effect of the semiconductor refrigeration material, the refrigeration function of the temperature regulating system 2 can be realized by applying a direct current to the semiconductor cooling-heating member 21, thereby delivering cold air to the storage cavity 101. By changing the polarity of the input voltage of the semiconductor cooling-heating member 21, i.e., changing the current direction of the semiconductor cooling-heating member 21, the heating function of the temperature regulating system 2 can be realized without changing the structure, thereby delivering hot air to the storage cavity 101.

To be specific, the temperature regulating process in the step S2 of the method provided herein includes the following steps.

In step S21, whether the initial temperature in the storage cavity 101 falls within the set temperature range is firstly determined; if not, then the temperature regulating system 2 performs the cooling action or the heating action (step (S22)) according to the demand to enable the temperature in the storage cavity 101 to fall within the set temperature range quickly and accurately, and then performs a heat preservation action (step (S23)); otherwise, the temperature regulation system 2 directly performs the heat preservation action (step (S23)).

When the temperature in the storage cavity 101 falls within the set temperature range, if the temperature regulating system 2 stops operating at this time, the temperature in the storage cavity 101 will change at a certain increasing (or reducing) rate, and finally reaches a temperature that is similar to the external ambient temperature of the storage device. Therefore, the heat preservation action in the method provided herein requires continuous operation of the temperature regulating system 2 to maintain the temperature inside the storage cavity.

Further, after step (S22), the temperature in the storage cavity 101 falls within the desired range of the storage device, and the external ambient temperature of the storage device is not likely to change largely or produces a change within the error allowable range within a short period of time. In this case, in the heat preservation phase (step (S23)) of the method provided herein, the temperature regulating system 2 is controlled to operate continuously under a lower insulation power (relative to the cooling power when the cooling action is performed, and the heating power when the heating action is performed), and only by dynamically adjusting the conversion between the cooling end surface and the heating end surface (i.e., the conversion of the DC power direction), the temperature in the storage cavity 101 can be maintained in the set temperature range in real time, which can satisfy the temperature conditions for the storage of cigars and achieve the goal of energy saving.

It should be noted that the temperature-holding power of the heat preservation phase in the method provided herein may be the default range of the temperature and humidity control system of the storage device, which is usually the factory setting of the storage device, or it may also be calculated by the temperature regulating system, which is not limited herein.

Further, in step (S23), the step of the first working end surface of the semiconductor cooling-heating member is dynamically adjusted to be the cooling end surface or the heating end surface includes the following steps.

The temperature in the storage cavity 101 is obtained in real time, if the temperature in the storage cavity 101 is greater than or equal to the lower limit of the set temperature range, then the first working end surface of the semiconductor cooling-heating member 21 is adjusted to the cooling end surface; and if the temperature in the storage cavity 101 is less than the lower limit of the set temperature range, then the first working end surface of the semiconductor cooling-heating member 21 is adjusted to the heating end surface.

In a preferred embodiment, in the heat preservation stage in step (S23) of the method provided herein, the temperature in the storage cavity 101 is required to be acquired in real time and compared with the set temperature range, and the comparison result is used as the basis for conversion between the cooling end surface and the heating end surface. In this way, the temperature in the storage cavity 101 can be maintained through a simple logical comparison with a very reliable performance.

Further, the temperature-holding power is obtained through the following steps.

A volume of the storage cavity 101, and an external ambient temperature and an external ambient humidity of the storage device are acquired.

The temperature-holding power is obtained based on the volume of the storage cavity 101, the external ambient temperature, the external ambient humidity and the set temperature range.

As the temperature control method of the existing cigar storage box generally ignores the influence of the use environment of the storage box on its internal inspection index, especially when the storage box is used in an environment with low temperature, high temperature, low humidity and/or high humidity, the temperature set by the existing method may be far different from the actual temperature, resulting in an ineffective preservation effect. Therefore, in method provided herein, the external ambient temperature and humidity of the storage device are considered in the heat preservation stage, so as to improve the precise regulation of the temperature in the storage cavity 101, thereby improving the storage and conservation effect of the storage device.

In addition, since when the temperature regulating system 2 stops operating, the temperature is the storage cavity 101 is tend to change toward the external ambient temperature of the storage device, and the temperature change speed is related to the volume of the storage cavity 101 and the external ambient humidity, in addition to the external ambient temperature. Therefore, in another preferred embodiment of the present disclosure, the method provided herein obtains the temperature-holding power of the temperature regulating system 2 during the heat preservation phase based on the volume of the storage cavity 101, the external ambient temperature, the external ambient humidity, and the set temperature range, so as to ensure the heat preservation effect while saving energy.

It should be noted that, in some embodiments, the mapping relationship among the volume of the storage cavity 101, the external ambient temperature, the external ambient humidity, the set temperature range, and the temperature-holding power can be summarized by pre-experimentation in a simulated environment to derive a mapping relationship table. Subsequently, in the heat preservation stage of the method provided herein, the temperature-holding power can be obtained by checking the mapping relationship table according to the volume of the storage cavity 101, the external ambient temperature, the external ambient humidity and the set temperature range. In other embodiments, the mapping relationship among the volume of the storage cavity 101, the external ambient temperature, the external ambient humidity, the set temperature range and the temperature-holding power can be summarized by pre-experimentation in a simulated environment to derive a mapping formula. In this case, in the heat preservation stage of the method provided herein, the temperature-holding power can be calculated according to the volume of the storage cavity 101, the external ambient temperature, the external ambient humidity, and the set temperature range. The acquisition of the temperature-holding power is not limited herein.

Further, the temperature regulating system performs the cooling action through the following steps.

An external ambient temperature of the storage device is acquired, and a cooling power of the semiconductor cooling-heating member 21 is obtained based on the initial temperature in the storage cavity 101, the external ambient temperature of the storage device, and the set temperature range. The first working end surface of the semiconductor cooling-heating member 21 is adjusted to the cooling end surface, and the operating power of the semiconductor cooling-heating member 21 is adjusted to the cooling power to execute the cooling action.

The temperature regulating system performs the heating action through the following steps.

The external ambient temperature of the storage device is acquired, and a heating power of the semiconductor cooling-heating member 21 is obtained based on the initial temperature in the storage cavity 101, the external ambient temperature and the set temperature range. The first working end surface of the semiconductor cooling-heating member 21 is adjusted to be the heating end surface, and the operating power of the semiconductor cooling-heating member 21 is adjusted to the heating power to execute the heating action.

Since the step (S22) of the method provided herein is for quickly and accurately enabling the temperature in the storage cavity 101 to fall within the set temperature range, only the temperature difference between the inside and outside of the storage cavity 101 and the set temperature range need to be taken into account when obtaining the cooling power and the heating power of the semiconductor cooling-heating member 21.

In an embodiment, the dehumidifying system 4 is arranged on the storage box 1. The dehumidifying system 4 includes a semiconductor cooling sheet 41, a condensation assembly 42 and a heat dissipation assembly 43 connected sequentially from inside to outside. The semiconductor cooling sheet 41 includes a cooling end surface and a heating end surface. The cooling end surface abuts the condensation assembly 42, and the heating end surface abuts the heat dissipation assembly 43. The condensation assembly 42 is configured to face toward the storage cavity 101, and the heat dissipation assembly 43 is configured to face toward an outside of the storage box 1.

Step (S3) includes the following steps.

(S311) The initial humidity in the storage cavity 101 is obtained, and whether the initial humidity of the storage cavity falls within the set humidity range is determined, if the initial humidity in the storage cavity 101 is not within the set humidity range, then step (S312) is performed; and if the initial humidity in the storage cavity 101 is within the set humidity range, then step (S313) is performed.

(S312) Whether a humidifying action or a dehumidifying action is executed is determined according to the initial humidity in the storage cavity 101 and the set humidity range, if the initial humidity in the storage cavity 101 is greater than an upper limit of the set humidity range, then the dehumidifying action is executed until a humidity in the storage cavity 101 falls within the set humidity range, and step (S313) is performed; and if the initial humidity in the storage cavity 101 is less than a lower limit of the set humidity range, then the humidifying action is executed until the humidity in the storage cavity 101 falls within the set humidity range, and step (S313) is performed.

(S313) A humidity-holding power is obtained, and an operating power of the semiconductor cooling sheet 41 is adjusted to be the humidity-holding power. The humidifying system is dynamically turned on and the dehumidifying system is turned off, or the dehumidifying system is turned on and the humidifying system is turned off, so as to keep the humidity in the storage cavity within the set humidity range in real time.

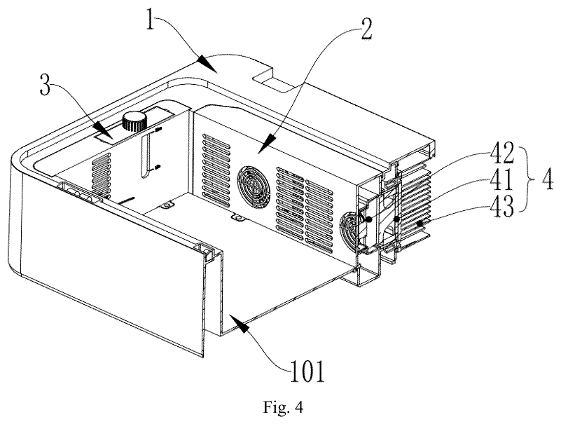

In an embodiment, the dehumidifying system 4 of the storage device includes a semiconductor cooling sheet 41, a condensation assembly 42 and a heat dissipation assembly 43 connected sequentially from inside to outside. The semiconductor cooling sheet 41 includes a cooling end surface and a heating end surface. The cooling end surface abuts the condensation assembly 42, and the heating end surface abuts the heat dissipation assembly 43, as shown in FIG. 4. When the dehumidifying system 4 is turned on, the gas to be dehumidified in the storage cavity 101 enters the condensation assembly 42 through the dehumidification inlet, and then is condensed into liquid droplets to be separated from the air due to the low-temperature cooling of the water vapor, thereby achieving the condensation and dehumidification. After that, the dehumidified air is then discharged from the condensation assembly 42 through the dehumidification outlet and flows back to the storage cavity 101.

It should be noted that the semiconductor cooling sheet 41 is made using the Peltier effect, which refers to the phenomenon that when the direct current flows through an electric coupling composed of two semiconductor materials, one end of the electric coupling absorbs heat and the other end of the electric coupling releases heat. In other words, the semiconductor cooling sheet 41 is made of two semiconductor materials to form a hot end and a cold end, where the cold end continuously absorbs heat to realize refrigeration, and the hot end continuously releases heat. In the present disclosure, the gas is dehumidified through semiconductor refrigeration, which omits the complex mechanical structure and effectively simplifies the structure and compression volume of the storage device. It facilitates the realization of silent dehumidification, and is safe, reliable, convenient and practical with a low manufacturing cost and a wide range of applications.

Specifically, in an embodiment, the humidity regulating process in step (S3) of the method provided herein includes the following steps.

In step (S31), whether the initial humidity in the storage cavity 101 is within the set humidity range is firstly determined: if it is not within the set humidity range, then, according to the demand, the humidifying system 3 performs the humidifying action or the dehumidifying system 4 performs the dehumidifying action, so that the humidity in the storage cavity 101 can quickly and accurately reach the set humidity range to enter the humidity-holding stage in step (S33); and if the initial humidity in the storage cavity 101 is within the set humidity range, then it directly enters the humidity-holding stage in step (S33), and the humidifying system 3 and the dehumidifying system 4 are turned on alternately to perform the humidity-holding action.

When the humidity in the storage cavity 101 is within the set humidity range, if the humidifying system 3 and the dehumidifying system stop operating at this time, the humidity in the storage cavity 101 will change at a certain increasing (or decreasing) rate, and finally reach a range that is similar to that of the external ambient humidity of the storage device. Therefore, in the humidity-holding phase, the humidifying system 3 and the dehumidifying system 4 are required to alternately operate to maintain the humidity in the storage cavity 101. Also, the temperature regulating system 2 consumes a portion of the moisture in the storage cavity 101 when it performs the cooling action, resulting in a decrease in the humidity in the storage cavity 101.

Further, after step (S32), the humidity in the storage cavity 101 is within the desired range of the storage device, and the external ambient humidity of the storage device is not likely to change largely, or produces a change within the error allowable range within a short period of time. As such, humidity-holding phase of step (S33), the dehumidifying system 4 is controlled to operate continuously under a lower humidity-holding power (relative to the dehumidifying power when performing the dehumidifying action), and at the same time the operating parameters of the humidifying system 3 remain unchanged. In this way, only by dynamically adjusting the alternate operation of the humidifying system 3 and the dehumidifying system 4, the real-time humidity in the storage cavity 101 is maintained in the set humidity range, which can satisfy the humidity conditions for the cigar storage while saving energy.

It should be noted that the humidify-holding power may be the default range of the temperature and humidity control system of the storage device, which is usually the factory setting of the storage device, or it may also be calculated by the dehumidifying system, and is not limited herein.

Preferably, in step (S313), the step of the humidifying system 3 is dynamically turned on and the dehumidifying system 4 is turned off, or the dehumidifying system 4 is turned on and the humidifying system 3 is turned off includes the following steps.

A humidity in the storage cavity 101 is obtained in real time. If the humidity in the storage cavity 101 is less than or equal to an upper limit of the set humidity range, then the humidifying system 3 is turned on, and the dehumidifying system 4 is turned off; and if the humidity in the storage cavity 101 is greater than the upper limit of the set humidity range, then the dehumidifying system 4 is turned on, and the humidifying system 3 is turned off.

Since the humidity for preservation of cigars is generally required to be higher than the external ambient humidity, the humidifying system 3 may be in a continuous operation when the real-time humidity in the storage cavity is less than or equal to the upper limit of the set humidity range, and when the humidity in the storage cavity is too high, then the dehumidifying system 4 is turned on for dehumidification. In the humidity-holding stage of the method provided herein, the humidity in the storage cavity 101 can be maintained merely by simple logic comparison, with a reliable performance.

Further, the humidity-holding power is obtained through the following steps.

A volume of the storage cavity 101, and an external ambient temperature and an external ambient humidity of the storage device are acquired.

The humidity-holding power is obtained based on the volume of the storage cavity 101, the external ambient temperature, the external ambient humidity and the set humidity range.

As the temperature control method of the existing cigar storage box generally ignores the influence of the use environment of the storage box on its internal inspection index, especially when the storage box is used in an environment with low temperature, high temperature, low humidity and/or high humidity, the humidity set by the existing method may be far different from the actual humidity, resulting in an ineffective preservation effect. Therefore, in method provided herein, the external ambient temperature and humidity of the storage device are considered in the humidity-holding stage, so as to improve the precise regulation of the humidity in the storage cavity 101, thereby improving the storage and conservation effect of the storage device.

In addition, since when the humidifying system 3 and the dehumidifying system 4 stop operating, the humidify is the storage cavity 101 is tend to change toward the external ambient humidify of the storage device, and the humidify change speed is related to the volume of the storage cavity 101 and the external ambient temperature, in addition to the external ambient humidify. Therefore, in another preferred embodiment of the present disclosure, the method provided herein obtains the humidify-holding power of the dehumidifying system 4 during the humidify preservation phase based on the volume of the storage cavity 101, the external ambient temperature, the external ambient humidity, and the set humidify range, so as to ensure the heat preservation effect while saving energy.

It should be noted that, in some embodiments, the mapping relationship among the volume of the storage cavity 101, the external ambient temperature, the external ambient humidity, the set humidify range, and the humidify-holding power can be summarized by pre-experimentation in a simulated environment to derive a mapping relationship table. Subsequently, in the humidify-holding stage of the method provided herein, the humidify-holding power can be obtained by checking the mapping relationship table according to the volume of the storage cavity 101, the external ambient temperature, the external ambient humidity and the set humidify range. In other embodiments, the mapping relationship among the volume of the storage cavity 101, the external ambient temperature, the external ambient humidity, the set humidify range and the humidify-holding power can be summarized by pre-experimentation in a simulated environment to derive a mapping formula. In this case, in the humidify preservation stage of the method provided herein, the humidify-holding power can be calculated according to the volume of the storage cavity 101, the external ambient temperature, the external ambient humidity, and the set humidify range. The acquisition of the humidify-holding power is not limited herein.

Further, the dehumidifying action is performed through the following steps.

A current temperature in the storage cavity 101, and an external ambient temperature and an external ambient humidity of the storage device are obtained.

A temperature compensation value is obtained based on the external ambient temperature and the external ambient humidity of the storage device and the current temperature in the storage cavity 101.

A target dehumidifying temperature is calculated by subtracting the temperature compensation value from the current temperature of the storage cavity 101.

A target dehumidifying power of the semiconductor cooling sheet 41 is obtained according to the target dehumidifying temperature.

The dehumidifying system is turned on, and the operating power of the semiconductor cooling sheet 41 is adjusted to be the target dehumidifying power to perform the dehumidifying action.

The humidifying action is performed through the following steps.

The humidifying system is turned on, and the humidifying action is executed in accordance with preset humidifying parameters.

The dehumidifying system 4 of the storage device provided herein uses a semiconductor refrigeration method for dehumidification. Based on the use characteristics of the semiconductor refrigeration method, only when there is a certain difference between the dehumidifying temperature of the dehumidifying system 4 (i.e., the cooling temperature of the semiconductor cooling sheet 41) and the current temperature in the storage cavity 101, can condensation and dehumidification be realized. At the same time, since the dehumidifying system 4 will also have a certain effect on the temperature in the storage cavity 101 during the dehumidifying process, to further accurately control the temperature, the temperature reduction due to dehumidification during the dehumidifying process needs to be taken into account as well. Therefore, to fully consider the above two situations, the present disclosure introduces a temperature compensation value in the dehumidifying process. Then, the cooling temperature of the semiconductor cooling sheet 41 in the dehumidifying system 4 is calculated by subtracting the temperature compensation value from the storage cavity 101, such that the dehumidifying power of the semiconductor cooling sheet 41 in the dehumidifying system 4 is obtained. The dehumidifying system 4 performs the dehumidifying action at the dehumidifying power, thereby realizing rapid and accurate dehumidification. In the control method provided herein, during the dehumidifying process, according to different external ambient temperatures and external ambient humidity, the current temperature in the storage cavity 101, a corresponding temperature compensation value is selected, so that the dehumidifying power of the dehumidifying system 4 can be accurately determined to realize the accurate dehumidification control.

It should be noted that, in some embodiments, the mapping relationship among the external ambient temperature, the external ambient humidity, and the temperature in the storage cavity 101 and the temperature compensation value in the present embodiment can be summarized by pre-experimentation in a simulated environment to derive a mapping relationship table. Therefore, in the dehumidifying stage, the temperature compensation value can be obtained by checking the mapping relationship table according to the external ambient temperature, the external ambient humidity, and the temperature in the storage cavity 101.

Further, in the storage device used herein, the humidifying system 3 may be an ultrasonic atomizer, the operating parameters of which may be set in accordance with the default parameters in the temperature and humidity control system. The execution and stopping of the humidifying action can be realized by respectively turning on and turning off the humidifying system 3 respectively, which is simple in logic and reliable in performance. Further, in the storage device used herein, the humidifying system 3 includes a wet water sponge and a humidifying fan. The air in the storage cavity 101 is driven by the humidifying fan to be moistened by the wet water sponge and then flows back to the storage cavity 101, thereby achieving the humidification of the air. The execution and stopping of the humidifying action can be realized by turning on and turning off the humidifying fan respectively, which is simple in structure and low-cost.

In an embodiment, step (S3) includes the following steps.

(S321) The humidifying system 3 is turned on to perform the humidifying action in accordance with preset humidifying parameters, and at the same time, an initial dehumidifying power is acquired. The dehumidifying system 4 is turned on. An operating power of the semiconductor cooling sheet 41 is adjusted to the initial dehumidifying power to perform the dehumidifying action.

(S322) A current humidity of the storage cavity 101 is acquired, and whether the current humidity of the storage cavity 101 falls within the set humidity range is determined; if the current humidity of the storage cavity 101 is not within the set humidity range, step (S323) is performed; and if the current humidity of the storage cavity 101 is within the set humidity range, step (S324) is performed.

(S323) The operating power of the semiconductor cooling sheet 41 is adjusted according to the humidity of the storage cavity and the set humidity range; if the humidity in the storage cavity 101 is greater than an upper limit of the set humidity range, the operating power of the semiconductor cooling sheet 41 is gradually increased, and the humidity the storage cavity 101 is acquired in real time until the humidity in the storage cavity 101 is within the set humidity range, and step (S324) is performed; and if the current humidity in the storage cavity 101 is less than a lower limit of the set humidity range, then the operating power of the semiconductor cooling sheet 41 is gradually reduced, and the humidity of the storage cavity 101 is acquired in real time until the humidity of the storage cavity 101 is within the set humidity range, and step (S324) is performed.

(S324) The humidifying action is performed by the humidifying system 3 in accordance with the preset humidifying parameters, and the dehumidifying action is performed by dehumidifying system 4 in accordance with the current dehumidifying power.

More specifically, in another embodiment of the present disclosure, humidity regulating process in step (S3) of the method provided herein includes the following steps.

The humidifying system 3 and the dehumidifying system 4 of the storage device are turned on simultaneously, i.e., the humidifying action and the dehumidifying action are carried out simultaneously. It should be noted that the humidifying parameters of the humidifying system 3 and the initial dehumidifying power of the dehumidifying system 4 may be default setting values of the temperature and humidity control system of the storage device, which are usually factory settings of the storage device, or they may be inputted and set by the user through a control panel, a smart phone, and other intelligent terminals, and are not limited herein.

Then, the humidity in the storage cavity 101 is compared with the set humidity range. If the current humidity in the storage cavity 101 is not within the set humidity range, the operating power adjustment of the semiconductor cooling sheet 41 of step (S323) is performed according to the demands; and if the humidity in the storage cavity 101 is within the set humidity range, then according to the current humidifying parameters and dehumidifying parameters, the humidifying action and the dehumidifying action are carried out simultaneously.

In the above humidity regulating process, the relative humidity in the storage cavity 101 can be regulated merely by adjusting the operating power of the semiconductor cooling sheet 41 in the dehumidifying system, which is very simple. In addition, since the temperature regulating system 2 is continuously adjusting the temperature in the storage cavity 101 during the humidity regulating process, and the external temperature and external humidity are also unchanged or undergoing minor changes, the dehumidifying method of the present embodiment also adequately takes into account and reflects the temperature in the storage cavity 101, the external temperature and the external humidity during the dehumidifying process, which is conducive to realizing accurate humidity control in the storage cavity 101 with less error.

In addition, since the operating power of the semiconductor cooling sheet 41 in the present dehumidifying method is gradually adjusted, i.e., the dehumidifying system 4 can gradually increase and decrease the operating power of the semiconductor cooling sheet 41 in accordance with the humidification intervals set by the system. As such, the humidity in the storage cavity 101 is more stable, thereby avoiding large fluctuations of the humidity in the storage cavity.

Preferably, step (S321) includes the following steps.

The humidifying system 3 is turned on to perform a humidifying action in accordance with a preset humidifying parameter. An initial dehumidifying power is obtained. The dehumidifying system 4 is turned on, and the operating power of the semiconductor cooling sheet 41 is adjusted to the initial dehumidifying power to perform a dehumidifying action.

After a first preset time, step (S322) is entered.

Step (S324) includes the following steps.

The humidifying action is performed by the humidifying system 3 in accordance with the preset humidifying parameters, and the dehumidifying action is performed by dehumidifying system 4 in accordance with the current dehumidifying power.

After a second preset time, step (S322) is entered.

In addition, in the humidifying process of the present control method, the first preset time and the second preset time are introduced respectively as the action time of the humidifying system 3 and the dehumidifying system 4.

After the first preset time, the humidity in the storage cavity 101 has sufficiently reflected the effects that the humidifying system 3 is performing the humidifying action in accordance with the preset humidifying parameters, and the dehumidifying system 4 is performing the dehumidifying action in accordance with the initial dehumidifying power, and then the comparison step is carried out at this time, which is more conducive to improving the comparison accuracy.

After step (S324), i.e., the storage cavity 101 has already undergone a first stage of the humidity regulating process, at this time, the humidity in the storage cavity 101 has already sufficiently reflected the humidity adjustment effect of the humidifying system 3 and the dehumidifying system 4 in the first stage. To avoid the influence of a large change in the temperature in the storage cavity 101 and movement of the storage device on the humidity in the storage cavity 101 after the humidity adjustment, in the method provided herein, after the second preset time, step (S322) is reentered for the comparison step, which is conductive to maintaining the humidity in the storage cavity.

It should be noted that the first preset time and the second preset time in the present control method may be the default time of the temperature and humidity control system of the storage device, which is usually the factory setting of the storage device. They may also be input and set by the user through the control panel, the smartphone, and other intelligent terminals, and are not limited herein.

In a second aspect, this application provides a system for controlling temperature and humidity in a storage device. The storage device includes a storage box 1, a temperature regulating system 2, a humidifying system 3 and a dehumidifying system 4. The storage box 1 is provided with a storage cavity 101.

The system includes an acquisition module, a temperature adjustment module; and a humidity adjustment module.

The acquisition module is configured to obtain a set temperature range and a set humidity range of the storage cavity 101.

The temperature adjustment module is configured to acquire an initial temperature in the storage cavity 101, and adjust the initial temperature to reach the set temperature range according to the initial temperature and the set temperature range through the temperature regulating system 2.

The humidity adjustment module is configured to obtain an initial humidity in the storage cavity 101, and adjust the initial humidity to reach the set humidity range through the humidifying system 3 and the dehumidifying system 4.

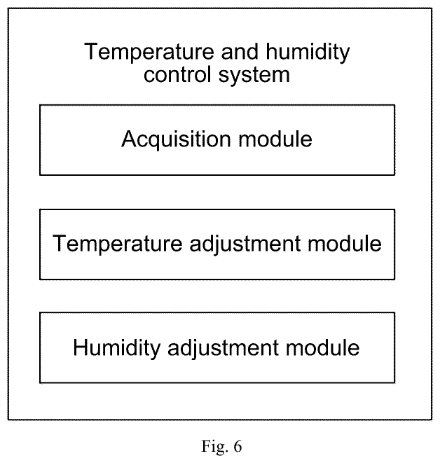

As shown in FIG. 6, the present disclosure provides a system for controlling temperature and humidity in a storage device to implement the aforementioned method, which includes an acquisition module, a temperature adjustment module; and a humidity adjustment module.

In a third aspect, this application provides a non-transitory computer-readable storage medium. The computer-readable storage medium is configured to store a computer program, and the computer program is configured to be executed by a processor to implement the aforementioned method.

The technical principles of the present disclosure are described above with reference to specific embodiments. These descriptions are only intended to explain the principles of the present disclosure, and should not be construed as a limitation of the scope of the present disclosure in any way. Based on the embodiments provided herein, other embodiments obtained by those skilled in the art without making creative effort shall fall within the scope of the present disclosure defined by the appended claims.

What is claimed is:

1. A method for controlling temperature and humidity in a storage device, the storage device comprising a storage box, a temperature regulating system, a humidifying system and a dehumidifying system, the storage box being provided with a storage cavity, and the method comprising:
(S1) obtaining a set temperature range and a set humidity range of the storage cavity;
(S2) obtaining an initial temperature in the storage cavity; and adjusting, by the temperature regulating system, a temperature in the storage cavity to reach the set temperature range according to the initial temperature and the set temperature range; and
(S3) obtaining an initial humidity in the storage cavity; and adjusting, by the humidifying system and the dehumidifying system, a humidity in the storage cavity to reach the set humidity range according to the initial humidity and the set humidity range.

2. The method of claim 1, wherein the temperature regulating system is arranged on the storage box; the temperature regulating system comprises a first conduction assembly, a semiconductor cooling-heating member and a second conduction assembly connected sequentially from inside to outside; the semiconductor cooling-heating member comprises a first working end surface and a second working end surface; the first working end surface is configured to abut the first conduction assembly; the second working end surface is configured to abut the second conduction assembly; the first conduction assembly is configured to face toward the storage cavity; and the second conduction assembly is configured to face toward an outside of the storage box; and
step (S2) comprises:
(S21) obtaining the initial temperature of the storage cavity, and determining whether the initial temperature falls within the set temperature range; if yes, proceeding to step (S23), otherwise, proceeding to step (S22);
(S22) determining whether the temperature regulating system performs a cooling action or a heating action according to the initial temperature of the storage cavity and the set temperature range;
if the initial temperature of the storage cavity is greater than an upper limit of the set temperature range, performing, by the temperature regulating system, the cooling action until the temperature in the storage cavity falls within the set temperature range, and proceeding to step (S23); and
if the initial temperature of the storage cavity is less than a lower limit of the set temperature range, performing, by the temperature regulating system, the heating action until the temperature in the storage cavity falls within the set temperature range, and proceeding to step (S23); and
(S23) obtaining a temperature-holding power; adjusting an operating power of the semiconductor cooling-heating member to the temperature-holding power; and
dynamically adjusting the first working end surface of the semiconductor cooling-heating member to be a cooling end surface or a heating end surface, so as to keep the temperature in the storage cavity within the set temperature range in real time.

3. The method of claim 2, wherein in step (S23), the step of dynamically adjusting the first working end surface of the semiconductor cooling-heating member to be the cooling end surface or the heating end surface comprises:
obtaining the temperature in the storage cavity in real time;
if the temperature in the storage cavity is greater than or equal to the lower limit of the set temperature range, adjusting the first working end surface of the semiconductor cooling-heating member to be the cooling end surface; and
if the temperature in the storage cavity is less than the lower limit of the set temperature range, adjusting the first working end surface of the semiconductor cooling-heating member to be the heating end surface.

4. The method of claim 2, wherein the temperature-holding power is obtained through steps of:
obtaining a volume of the storage cavity, and obtaining an external ambient temperature and an external ambient humidity of the storage device; and
obtaining the temperature-holding power based on the volume of the storage cavity, the external ambient temperature, the external ambient humidity and the set temperature range.

5. The method of claim 2, wherein the temperature regulating system performs the cooling action through steps of:
obtaining an external ambient temperature of the storage device;
obtaining a cooling power of the semiconductor cooling-heating member based on the initial temperature in the storage cavity, the external ambient temperature, and the set temperature range;
adjusting the first working end surface of the semiconductor cooling-heating member to be the cooling end surface; and
adjusting the operating power of the semiconductor cooling-heating member to be the cooling power to execute the cooling action; and
the temperature regulating system performs the heating action through steps of:
obtaining the external ambient temperature;
obtaining a heating power of the semiconductor cooling-heating member based on the initial temperature in the storage cavity, the external ambient temperature and the set temperature range;
adjusting the first working end surface of the semiconductor cooling-heating member to be the heating end surface; and
adjusting the operating power of the semiconductor cooling-heating member to be the heating power to execute the heating action.

6. The method of claim 1, wherein the dehumidifying system is arranged on the storage box; the dehumidifying system comprises a semiconductor cooling sheet, a condensation assembly and a heat dissipation assembly connected sequentially from inside to outside; the semiconductor cooling sheet comprises a cooling end surface and a heating end surface; the cooling end surface is configured to abut the condensation assembly, and the heating end surface is configured to abut the heat dissipation assembly; and the condensation assembly is configured to face toward the storage cavity, and the heat dissipation assembly is configured to face toward an outside of the storage box; and
step (S3) comprises:
(S311) obtaining the initial humidity in the storage cavity, and determining whether the initial humidity falls within the set humidity range;
if the initial humidity is not within the set humidity range, proceeding to step (S312); and
if the initial humidity is within the set humidity range, proceeding to step (S313);
(S312) determining whether to execute a humidifying action or a dehumidifying action according to the initial humidity and the set humidity range;
if the initial humidity is greater than an upper limit of the set humidity range, executing the dehumidifying action until a humidity in the storage cavity falls within the set humidity range, and proceeding to step (S313); and
if the initial humidity is less than a lower limit of the set humidity range, executing the humidifying action until the humidity in the storage cavity falls within the set humidity range, and proceeding to step (S313); and
(S313) obtaining a humidity-holding power; adjusting an operating power of the semiconductor cooling sheet to be the humidity-holding power; dynamically turning on the humidifying system and turning off the dehumidifying system, or turning on the dehumidifying system and turning off the humidifying system, so as to keep the humidity in the storage cavity within the set humidity range in real time.

7. The method of claim 6, wherein the dehumidifying action is performed through steps of:
obtaining the temperature of the storage cavity, and obtaining an external ambient temperature and an external ambient humidity of the storage device;
obtaining a temperature compensation value based on the external ambient temperature and the external ambient humidity of the storage device and the temperature of the storage cavity;
calculating a target dehumidifying temperature by subtracting the temperature compensation value from the temperature of the storage cavity;
obtaining a target dehumidifying power of the semiconductor cooling sheet according to the target dehumidifying temperature; and
turning on the dehumidifying system, and adjusting the operating power of the semiconductor cooling sheet to be the target dehumidifying power to perform the dehumidifying action; and
the humidifying action is performed through steps of:
turning on the humidifying system, and executing the humidifying action in accordance with preset humidifying parameters.

8. The method of claim 1, wherein the dehumidifying system is arranged on the storage box; the dehumidifying system comprises a semiconductor cooling sheet, a condensation assembly and a heat dissipation assembly connected sequentially from inside to outside; the semiconductor cooling sheet comprises a cooling end surface and a heating end surface; the cooling end surface is configured to abut the condensation assembly, and the heating end surface is configured to abut the heat dissipation assembly; and the condensation assembly is configured to face toward the storage cavity, and the heat dissipation assembly is configured to face toward an outside of the storage box; and
step (S3) comprises:
(S321) turning on the humidifying system, and performing a humidifying action in accordance with preset humidifying parameters, and at the same time, acquiring an initial dehumidifying power; turning on the dehumidifying system; and adjusting an operating power of the semiconductor cooling sheet to the initial dehumidifying power to perform a dehumidifying action;
(S322) obtaining the humidity of the storage cavity, and determining whether the humidity of the storage cavity falls within the set humidity range;
if the humidity of the storage cavity is not within the set humidity range, proceeding to step (S323); and
if the humidity of the storage cavity is within the set humidity range, proceeding to step (S324);
(S323) adjusting the operating power of the semiconductor cooling sheet according to the humidity of the storage cavity and the set humidity range;
if the humidity of the storage cavity is greater than an upper limit of the set humidity range, increasing the operating power of the semiconductor cooling sheet until the humidity of the storage cavity falls within the set humidity range at the same time of acquiring the humidity of the storage cavity in real time, and proceeding to step (S324); and
if the humidity of the storage cavity is less than a lower limit of the set humidity range, reducing the operating power of the semiconductor cooling sheet until the humidity of the storage cavity falls within the set humidity range at the same time of acquiring the humidity of the storage cavity in real time, and proceeding to step (S324); and
(S324) performing, by the humidifying system, the humidifying action in accordance with the preset humidifying parameters; and performing, by the dehumidifying system, the dehumidifying action in accordance with a current dehumidifying power.

9. A system for controlling temperature and humidity in a storage device, the storage device comprising a storage box, a temperature regulating system, a humidifying system and a dehumidifying system, and the storage box comprising a storage cavity, and the system comprising:
an acquisition module;
a temperature adjustment module; and
a humidity adjustment module;
wherein the acquisition module is configured to obtain a set temperature range and a set humidity range of the storage cavity;
the temperature adjustment module is configured to acquire an initial temperature in the storage cavity, and adjust a temperature in the storage cavity to reach the set temperature range according to the initial temperature and the set temperature range through the temperature regulating system; and
the humidity adjustment module is configured to obtain an initial humidity in the storage cavity, and adjust a humidity in the storage cavity to reach the set humidity range according to the initial humidity and the set humidity range through the humidifying system and the dehumidifying system.

10. A non-transitory computer-readable storage medium, wherein the computer-readable storage medium is configured to store a computer program; and the computer program is configured to be executed by a processor to implement the method of claim 1.
